(19) United States
(12) Patent Application Publication
(10) Pub. No.: US 2003/0200550 A1
(43) Pub. Date: Oct. 23, 2003

(54) Internet video recording system and method

(76) Inventors: Yehuda Antebi, Hod Hasharon (IL); Alon Brener, Rishon Le Zion (IL); Nir Cohen, Netanya (IL)

Correspondence Address: DR. MARK FRIEDMAN LTD., C/O BILL POLKINGHORN, DISCOVERY DISPATCH, 9003 FLORIN WAY, UPPER MARLBORO, MD, 20772, US

(21) Appl. No.: 10/123,410

(22) Filed: Apr. 17, 2002

(51) Int. Cl. H04N 7/173; H04N 5/222; H04N 5/38; G09G 5/00

(52) U.S. Cl. 725/109; 725/110; 725/112; 725/113; 348/722; 348/723; 345/723; 345/731

(57) ABSTRACT

An Internet Video Recording system and method, for enabling recording and management of dynamic Web content, such that changed content can be automatically captured and viewed at the user's convenience. Accordingly, the user navigates to the desired destination, presses the recording button, fills in, confirms and configures the recording parameters. The software monitors elected content for changes, and records the chosen Web site content each time the elected content changes. The user can subsequently use the application of the present invention to view and manage the tracked content at his/her convenience. Content changes from a plurality of sources can similarly be detected and recorded in parallel.

### FIELD AND BACKGROUND OF THE INVENTION

1. Field of the Invention

The present invention relates to the field of Internet navigation, and more particularly, to a system and method for enabling recording and offline browsing of dynamic web page content.

2. Description of the Related Art

As a result of the wide acceptance and use of the Internet, computer enthusiasts and business users (collectively, l?users II) have become dependent on the Internet to receive information and content related to particular points of interest. For example, many users now rely on the World Wide Web (WWW) to conduct routine tasks such as performing research about a particular topic, retrieving content related to particular events, and engaging in commerce with merchants who operate electronic storefronts. In many respects, the WWW has enabled increased and efficient distribution of information and has opened whole new markets. The growth and expansion of the WWW has created a corresponding and ever-changing expanse of content that may be retrieved and processed by users.

A growing proportion of the content available to users of the Internet is dynamic, changing content. Since the Internet enables updating and distribution of content such as up-to-date prices, scores, news, alerts etc., there is an increasing need for tools that are able to capture this dynamic content. Typically, browsers provide a page saving function that enables a user to save a particular Web page for later usage, or alternatively to send the page to another user via an email message. Such a function, however, only saves the static page, with the content at the time of saving. The user can subsequently open the page and if necessary refresh the page to receive the latest version. However all changes that occurred to the page from the time of saving until the time of refreshing cannot be seen by the user.

There are various content tracking tools that enable noticing users of content changes. Amazon alerts (www.amazon.com), for example, provide information tracking and the sending of updates to consumers by email. Yahoo alerts (www.yahoo.com), for example, enable personalized Price Movement tracking, news update tracking etc., wherein users can be notified in real time of changes when the content being tracked exceeds set limits. Yahoo alerts also provide Hourly Alerts, where changes are sent to the users at specified times. These alerts can be sent to a user' email box, Yahoo messaging application, or mobile device.

These tools, however, cannot provide users with information about all the changes that occurred to content during a chosen period. Certain sites provide services in which they compile, summarize and present content changes, such as stock tracking sites, but these are the product of particular content analysis, such as statistical tools, and cannot typically be achieved for all content from any site. These tools, furthermore, do not enable management of the changed content, according to the users needs.

There is thus a widely recognized need for, and it would be highly advantageous to have, a system or method that can enable recording of any Web content when users are not present, and enabling offline browsing and management of this content at the users convenience, such that the user can view all content changes over a chosen period of

### SUMMARY OF THE INVENTION

According to the present invention there is provided an Internet Video system and method for enabling recording of dynamic Web content, such that changing content can be automatically captured and viewed at the user's convenience.

According to the present invention, the user navigates to the desired destination, using navigational software such as Internet browser software, presses the recording button (an icon in the browser window), fills in the recording parameters (Date, time) and presses “OK”. The software monitors selected content for changes, and records the chosen Web site each time the selected content changes. The user can subsequently use the application of the present invention to view and manage the tracked content at his/her convenience.

The Internet Video system according to the present invention includes a Management module for managing the system, a Synchronization module for initiating user tasks, a Communication module for locating and recording content, and a View module for viewing recorded content.

### BRIEF DESCRIPTION OF THE DRAWINGS

The invention is herein described, by way of example only, with reference to the accompanying drawings, wherein:

FIG. 1 is an illustration of the components and the operational flow between them, according to the present invention.

FIG. 2 is an illustration of the recording icon in a typical browser window.

FIG. 3 is an illustration of a typical interface for configuring Web page data and recording preferences.

FIG. 4 is an illustration of the typical interface of the View Manager.

FIG. 5 is an illustration of a presentation window for viewing recorded

FIG. 6 is an illustration of the process by which changing Web content is detected and recorded.

FIG. 7 illustrates the method whereby the management module configures recording parameters.

### DESCRIPTION OF THE PREFERRED EMBODIMENT

The present invention relates to an Internet Video Recording system and method, for enabling recording of Web content, such that dynamic content can be automatically captured and viewed at the user's convenience.

The following description is presented to enable one of ordinary skill in the art to make and use the invention as provided in the context of a particular application and its requirements. Various modifications to the preferred embodiment will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed.

Specifically, the present invention can be used to enable a dynamic Web content recording apparatus. This apparatus enables tracking of business or other dynamic information on the Internet, such that the user who is not willing or able to monitor content by constantly observing the screen, can set the apparatus to record chosen Web pages in which content changes have been detected. In this way, the Web content data can be automatically saved to the users disk, and viewed and managed at the user's convenience.

The present invention may be compared to a video recorder programmed to record TV programs at different times. However the present invention is far more flexible, enabling recording from a plurality of content sources simultaneously, according to customized commands.

The principles and operation of a system and a method according to the present invention may be better understood with reference to the drawings and the accompanying description, it being understood that these drawings are given for illustrative purposes only and are not meant to be limiting, wherein:

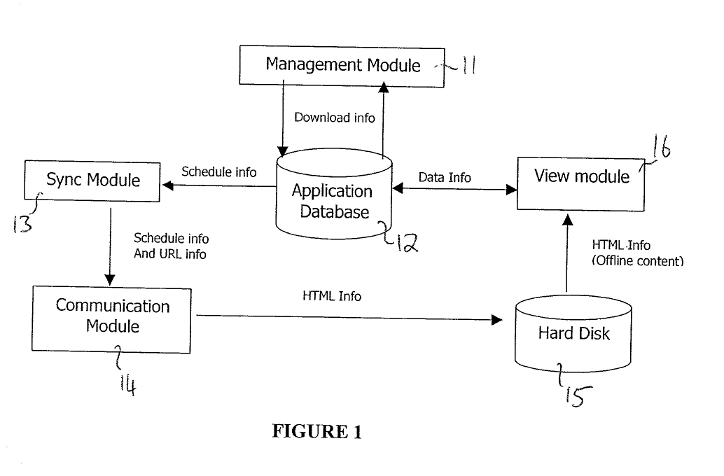

The application of the present invention, which is typically a downloaded or otherwise loaded or configured executable file, is comprised of four main modules, as can be seen with reference to FIG. 1: a Management module, Synchronization module, Communication module and a View module. Additional elements that are integral to the functioning of the present invention are the application Database (DB) and hard disk of the user's PC.

1. Management Module 11:

This module manages the data in the application database 12 (which includes mapped pages, as well as user profiles, user preferences and system commands), as well as analyzing the data and initiating commands to the database from other modules. The application database is typically a collection of application data stored as a series of database files in a subdirectory dedicated for storing the application data.

A typical database file, according to the present invention, may be created using standardized database application software, such as Access 2000 from Microsoft Corporation. Such a database file may include a “workdata” table with fields such as:

| Name of Field | Function |
|---|---|
| ID | Primary Key |
| LocationName | Site Name |
| SiteUrl | Site Address |
| LocationUrl | True Address |
| LastIndex | Number of Recordings Executed |
| Status | Recording Status |
| StartDate | Beginning of Recording Date |
| StartTime | Beginning of Recording Time |
| StopDate | End of Recording Time |
| Stop Time | End of Recording Date |
| Date | Date of Adding of the Data Entry |

The Status field may be further defined as:

| Options | Definitions |
|---|---|
| Null | Waiting to Start Recording |
| Recording | Recording |
| Paused | Stopping Recording by the User |
| Finished | Finished Recording |

The hard disk of the user records the data, such as site HTML source code and images. The data is recorded according to its PATH, wherein the software completes the PATH with the recording ID, from the “workdata” table.

Managing the content also refers to various alternative user functions or tasks, including configuring, controlling, analyzing, editing and communicating this content. Furthermore, the Management module enables adding, deleting or editing of user preferences and tasks, by manipulating application data in the application database.

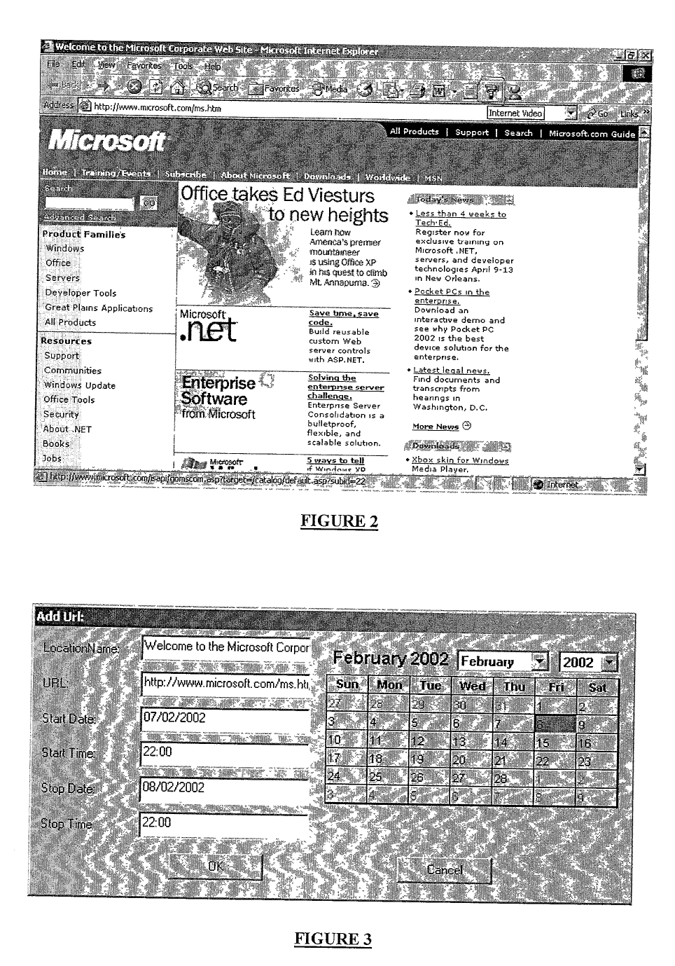

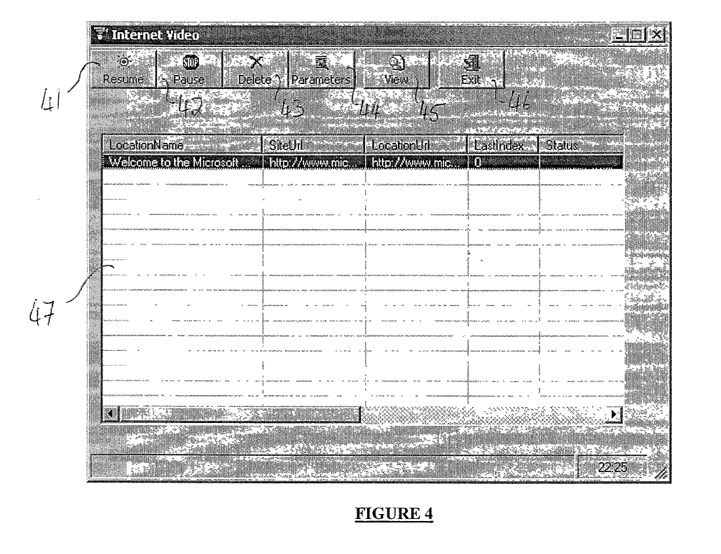

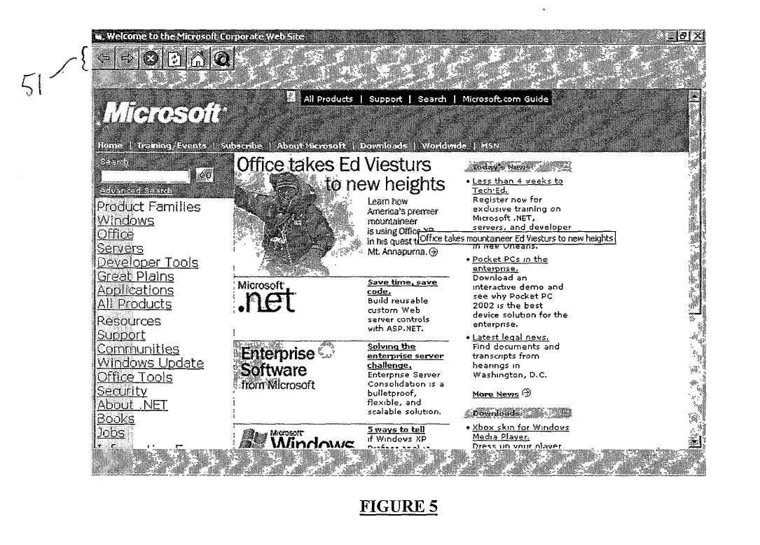

A new Web page may be added to the Internet Recording application by clicking on an icon (hereinafter referred to as a, “recording icon”) in the browser application window, such as can be seen in FIG. 2 (the circled icon in the tool bar towards the top of the browser window). Clicking on such an icon can optionally initiate automatic or semi-automatic recording of the present Web page data into the View module database. The user can subsequently enter individualized parameters in order to record and manage the present content. The user can view recorded data that is stored in the application database, by accessing the View module. This can be done, for example, by clicking on a “View” icon (as can be seen in FIG. 4).

The clicking on such a recording icon (such as can be seen in FIG. 2) can launch a recording window, an example of which can be seen in FIG. 3, which contains the current data of the Web page being viewed, and a calendar to aid determination of recording starting and stopping dates, as well as starting and stopping times for recording. Clicking on “OK” adds the page to the application database.

FIG. 4 illustrates an example of the main screen (interface) of the Management module. This interface provides a table wherein the monitored content sources and the preferences for each source may be viewed and managed. The “Resume” button 41 enables continuing the recording of a stopped caused) entry. The “Pause” button 42 enables pausing (stopping) recording of an entry. The “Delete” button 43 enables deleting an entry in the system database, as well as the entry's data from the user's hard disk. The “Parameters” button 44 enables changing the parameters of a chosen entry. The “View” button 45 enables presenting of the chosen content source (the latest page), as can be seen in FIG. 5. The “Exit” button 46 enables exiting the application and ceasing all recording. As is clear from FIG. 4, the Management module enables the addition of a plurality of content sources, presented in a database format 47, and the user interface enables the simultaneous tracking of all these sources.

2. Synchronization module 13:

This module, which includes a timer, is used to initiate the download process according to user defined schedule information (pace) and other user defined criteria (stored in the DB). The timer is a typical timer such as that provided in Visual Basic development software (by Microsoft Corporation). From the moment when the timer is functional, each required time period for recording is configured in advance, and the Synchronization module 13 subsequently scans the database to determine when the time arrives to activate at least one of the “workdata” table entries. When such a time arrives, the Synchronization module 13 sends the data entry to the Communication Module in order to download and compare the latest content. The Synchronization module 13 enables recording of content from content sources constructed in a plurality of computer languages.

3. Communication module 14:

The Communication module 14 locates selected content sources, downloads the changed content, and detects if there are changes in the source content. This detection entails comparing a prior recording and a current recording of content, such that if a difference in the content is detected (according to significant source code changes, as defined by the user), the new content data (HTML and image data) is recorded on the user's hard disk drive 15, and the “LastIndex” field of the “workdata” table (DB) is accordingly updated.

4. View module 16:

This module enables viewing of the recorded information. Viewing incorporates offline navigation (browsing) through various recorded pages, thereby providing functions such as rewinding (backwards), fast forwarding (forward) etc.

FIG. 5 illustrates a screen shot of the presentation of a recorded page by the View module. As can be seen in the figure, this interface window contains navigation buttons 51. These navigation buttons include “backward” and “forward” buttons (left and right arrows), which enable navigating between the various versions of the content source (the various recorded pages from each particular content source). Viewing of the content can be executed one slide at a time, automatically, or according to any other configured viewing timetable or means.

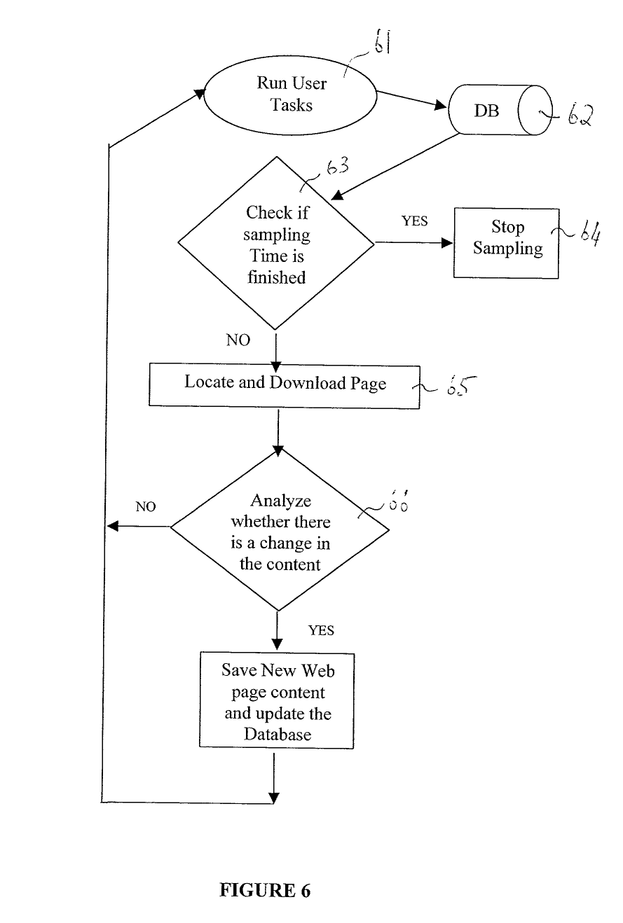

The process of recording dynamic Web content, according to the present invention, is as follows, as can be seen with reference to FIG. 6:

i. The Synchronization module constantly runs user tasks 61, according to entries in a database 62. Accordingly, a timer in the Synchronization module constantly checks the database fields for dates and times when recordings are required. The Synchronization module thereby detects when a particular entry in the database requires a task to be executed at a particular time and date. When that time arrives, the timer initiates a command, which is sent from the Synchronization module to the Communication module, to update the content.

ii. The Communication module then checks 63 the database entry to determine whether the time and data limits for the recording series are active or expired. If the time or date has lapsed, this signals an end to the search process and there is no further content location or recording 64.

iii. If neither the time nor the date has lapsed, the Communication module initiates an Internet connection, where necessary, and opens a Web browser window in order to locate and download 65 the updated content of the selected Web page, according to the particular database entry. The Communication module subsequently downloads relevant content from the Internet/Intranet source (Web page).

iv. The Communication module subsequently analyzes 66 whether the content from the source is different from the previous version downloaded, thereby detecting content changes. In the case where the content has not changed, the system maintains the original page content and resumes the running of user tasks 61. In the case where the content has changed, according to significant source code changes, the content source (HTML and Image data) is recorded 67 in the hard disk of the user's PC, and the application database is accordingly updated.

A user may optionally define specific tags to monitor for changes. For example, the system can require filtering/scanning the source pages such that only text tabs are checked for changes, and not sound, graphic, flash or video tabs. The Communication module can send an alert to the View module to inform the View module that new textual content has been recorded.

Configuration of recording tasks by the Management Module:

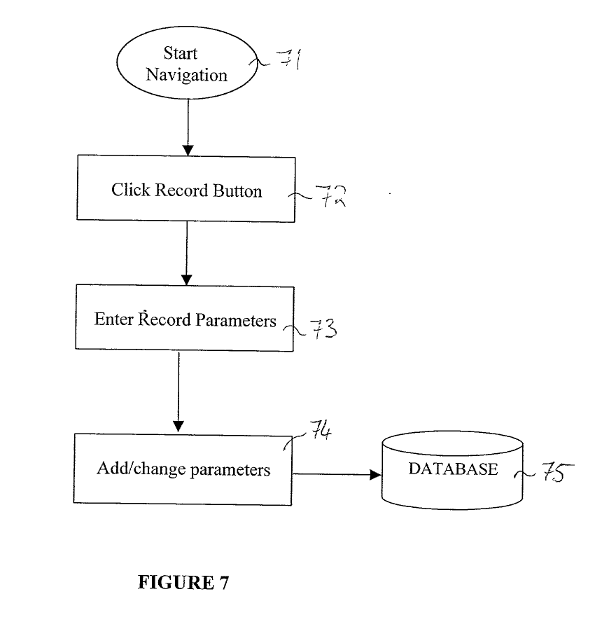

A typical configuration of a recording task can be seen with reference to FIG. 7.

1. The user initiates navigation 71, using a standard Web browser or a browser window of the View module, to locate a relevant content source;

2. Having reached a source for which the user requires tracking, the user clicks the (“Record” button 72 (see, for example, the icon of FIG. 2) to enter the current content source (page) address into the DB;

3. The user configures personalized recording criteria parameters) 73 for the content source recording, such as start time, start date, finish time, finish date and frequency of recordings. The user can configure particular parts of the content that are to be tracked, by determining at least one particular tag for tracking. In this way, a particular aspect (or aspects) of the content of a chosen content source may be tracked by the Internet Video system of the present invention; and

4. The user can confirm the recording criteria and at any time add/change 74 various fields in the database of the application, as new or existing entries. These entries are typically recorded in a MDB file in the application DB 75.

### EXAMPLE

An example of the usage of the present invention is in tracking the progress of an online auction, by a user who anticipates being unable to manually track the progress of the auction. The user can record product price changes in an online auction, by adding the URL of a chosen product page to a recording list. The user can determine, for example, that a particular page, which represents an ongoing auction for a particular product, requires recording for expected changes every 15 minutes for the next 3 days. In this way, the user can, at his/her own convenience, browse, view, edit, forward, analyze and manage the changed content of the auction.

According to an additional embodiment of the present invention, a user can conduct a plurality of tracking and recording sessions from a plurality of Web page simultaneously. The user can accordingly configure, control and manage dynamic content according to his/her needs for any number of content sources. Furthermore, the system of the present invention enables recording of content from content sources constructed in a plurality of computer languages.

In an additional embodiment of the present invention, the management software provides statistical analyses and site performance results, and provides user alerts for user-defined reasons (such as when a product price reaches a desired value).

The foregoing description of the embodiments of the invention has been presented for the purposes of illustration and description. It is not intended to be exhaustive or to limit the invention to the precise form disclosed. It should be appreciated that many modifications and variations are possible in light of the above teaching. It is intended that the scope of the invention be limited not by this detailed description, but rather by the claims appended hereto.

What is claimed is:

1. An Internet Video system for recording dynamic Internet content, comprising:
a Management module for managing the system;
a Synchronization module for initiating user tasks, from said Management module, at determined times;
a Communication module for locating and recording content, according to tasks initiated by said Synchronization module; and
a View module for viewing said recorded content.

2. The Internet Video system of claim 1, wherein said managing of the system further comprises functions selected from the group consisting of configuration of application database, controlling the Internet Video system, editing of recorded content, analyzing of recorded content, communicating of recorded content and manipulation of recorded content.

3. The Internet Video system of claim 1, wherein said Communication module enables recording of a plurality of content sources simultaneously.

4. The Internet Video system of claim 2, wherein said Communications module enables comparing at least one selected part of each of said content sources, for recording dynamic changes in said content part.

5. The Internet Video system of claim 1, wherein said Synchronization module enables recording of content from content sources constructed in a plurality of computer languages.

6. A method for recording dynamic content from a network-based content source, comprising:
locating a relevant content source, by a user, using an Internet browsing application;
recording said content source in an application database;
opening a Management module, said module having data from said content source; and
configuring personalized tracking criteria for said content source, according to said data, by said user.

7. The method of claim 6, further comprising:
downloading new content from said content source, according to said personalized tracking criteria, by a Communications module;
determining if there are significant changes between said new content and previously recorded content, by said Communications module; and
if there are significant changes in said new content source, recording said new content, by said Communications model.

8. The method of claim 6, wherein if no changes are found in said new content, deleting said downloaded new content by said Communication module.

9. The method of claim 6, further comprising viewing said recording of said changes to said content, by a View module.

10. The method of claim 6, further comprising analyzing said recording of said changes to said content, by said Management module.

11. The method of claim 6, further comprising editing said recording of said changes to said content, by said Management module.

12. The method of claim 6, further comprising alerting a user regarding changes to said content, according to user-defined rules.

13. The method of claim 6, wherein said locating a relevant content source further comprises selecting at least one part of said source, said selecting requiring selection of at least one tag from said content source.

14. The method of claim 6, wherein said recording dynamic content is enabled for multiple network-based content sources simultaneously.

15. The method of claim 6, wherein said personalized tracking criteria are recorded as personalized events in an application database, as MDB files.
